(19) United States
(12) Patent Application Publication
(10) Pub. No.: US 2025/0222918 A1
(43) Pub. Date: Jul. 10, 2025

(54) CONTROL DEVICE FOR HYBRID ELECTRIC VEHICLE

(71) Applicant: TOYOTA JIDOSHA KABUSHIKI KAISHA, Toyota-shi (JP)

(72) Inventors: Keisuke HARA, Nisshin-shi (JP); Koichiro Muta, Okazaki-shi (JP); Yoshihisa Umemura, Nagoya-shi (JP); Yasutaka Tsuchida, Toyota-shi (JP)

(73) Assignee: TOYOTA JIDOSHA KABUSHIKI KAISHA, Toyota-shi (JP)

(21) Appl. No.: 18/987,407

(22) Filed: Dec. 19, 2024

(30) Foreign Application Priority Data
Jan. 9, 2024 (JP) 2024-001359

(51) Int. Cl. B60W 20/13; B60W 10/08

(52) U.S. Cl. CPC B60W 20/13; B60W 10/08; B60W 2400/00; B60W 2510/244; B60W 2520/10

(57) ABSTRACT

A control device for a hybrid electric vehicle including an engine and a motor as traction power sources, the control device comprising: a switching unit configured to switch the hybrid electric vehicle to hybrid driving when a requested driving force requested to the hybrid electric vehicle is equal to or greater than a switching value, and to switch the hybrid electric vehicle to motor driving when the requested driving force is less than the switching value, the hybrid driving being driving in which the hybrid electric vehicle travels with power of the engine, and the motor driving being driving in which the hybrid electric vehicle travels with power of the motor; an acquisition unit that acquires a temperature of the engine; and a setting unit that sets the switching value to a larger value as the temperature of the engine decreases.

### CROSS-REFERENCE TO RELATED APPLICATION

This application claims priority to Japanese Patent Application No. 2024-001359 filed on Jan. 9, 2024, incorporated herein by reference in its entirety.

### BACKGROUND

### 1. Technical Field

The present disclosure relates to control devices for hybrid electric vehicles.

### 2. Description of Related Art

There is a technique of controlling the fuel injection amount etc. based on the temperature of an engine (see, for example, Japanese Unexamined Patent Application Publication No. 2013-204466 (JP 2013-204466 A)).

### SUMMARY

Hybrid electric vehicles equipped with an engine and a motor as traction power sources are known in the art. Hybrid driving with the power of the engine when the temperature of the engine is low may reduce the efficiency of the engine, which may cause a decrease in fuel efficiency.

An object of the present disclosure is to provide a control device for a hybrid electric vehicle that reduces a decrease in fuel efficiency.

The above object can be achieved by a control device for a hybrid electric vehicle including an engine and a motor that are traction power sources. The control device includes:
a switching unit configured to switch the hybrid electric vehicle to hybrid driving when a requested driving force requested to the hybrid electric vehicle is equal to or greater than a switching value, and to switch the hybrid electric vehicle to motor driving when the requested driving force is less than the switching value, the hybrid driving being driving in which the hybrid electric vehicle travels with power of the engine, and the motor driving being driving in which the hybrid electric vehicle travels with power of the motor; an acquisition unit configured to acquire a temperature of the engine; and a setting unit configured to set the switching value to a larger value as the temperature of the engine decreases.

The acquisition unit may be configured to acquire an amount of charge in a battery that is a power source of the motor.

The setting unit may be configured to set the switching value to a larger value as the amount of charge in the battery increases.

The acquisition unit may be configured to acquire a vehicle speed of the hybrid electric vehicle.

The setting unit may be configured to set the switching value to a larger value as the vehicle speed decreases.

The present disclosure can provide a control device for a hybrid electric vehicle that reduces a decrease in fuel efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a hybrid electric vehicle;

FIG. 2 is a flow chart illustrating a travel switching control;

FIG. 3A is a diagram illustrating a map in which switching values are defined; and

FIG. 3B is a diagram illustrating a map in which switching values are defined.

### DETAILED DESCRIPTION OF EMBODIMENTS

### Schematic Configuration of Hybrid Electric Vehicle

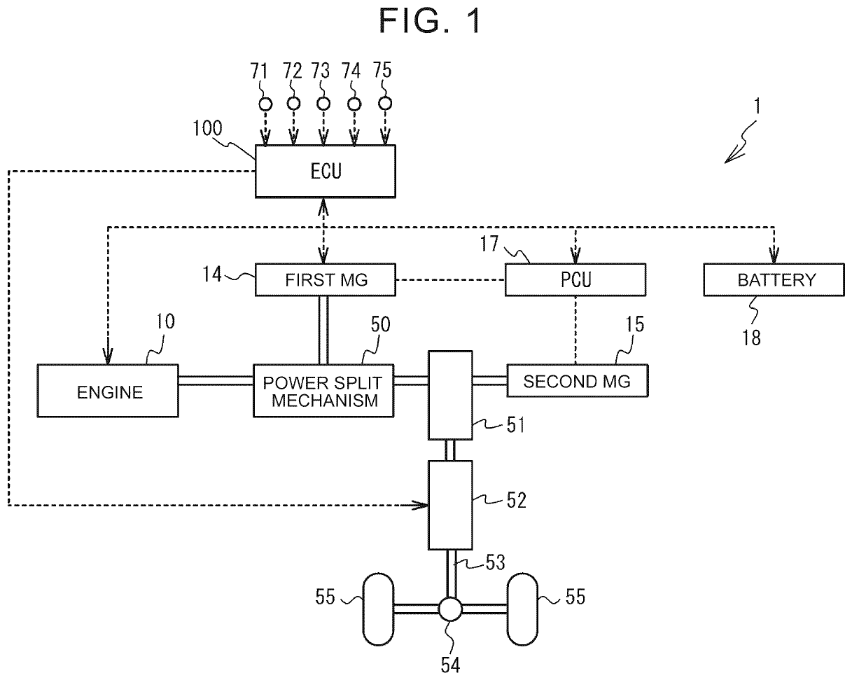

FIG. 1 is a schematic configuration diagram of a hybrid electric vehicle 1 according to the present embodiment. Hybrid electric vehicle 1 includes an ECU (Electronic Control Unit) 100, an engine 10, a first motor generator (hereinafter referred to as “first MG (Motor Generator)”) 14, a second motor generator (hereinafter referred to as “second MG”) 15, a PCU (Power Control Unit) 17, a battery 18, a power split mechanism 50, a transmission mechanism 51, a transmission 52, a drive shaft 53, a differential gear 54, and drive wheels 55. In the present embodiment, the engine 10 includes four cylinders. If the engine 10 has a plurality of cylinders, the number of cylinders is not limited to four. The engine 10 is a gasoline engine, but is not limited thereto and may be a diesel engine. The engine 10, first MG 14, and second MG 15 are driving power sources of hybrid electric vehicle 1.

The first MG 14 and the second MG 15 each have a function as a motor for outputting torque by supplying electric power, and a function as a generator for generating regenerative electric power by applying torque. The first MG 14 and the second MG 15 are electrically connected to the battery 18 via a PCU 17. PCU 17 supplies power from the battery 18 to the first MG 14 or the second MG 15. That is, the battery 18 is a power source of the first MG 14 and the second MG 15. PCU 17 causes the battery 18 to receive the regenerative electric power generated in the first MG 14 or the second MG 15.

The power split mechanism 50 mechanically connects the crankshaft of the engine 10, the rotational shaft of the first MG 14, and the output shaft of the power split mechanism 50. An output shaft of the power split mechanism 50 is connected to the transmission mechanism 51. The rotary shaft of the second MG 15 is connected to the transmission mechanism 51. The transmission mechanism 51 is connected to the transmission 52. The transmission 52 is connected to the drive shaft 53. The driving forces of the engine 10, the first MG 14, and the second MG 15 are transmitted to the driving wheels 55 via the transmission mechanism 51, the transmission 52, the drive shaft 53, and the differential gear 54.

The transmission 52 is a stepped type automated transmission provided between the second MG 15 and the drive shaft 53. The transmission 52 changes the gear ratio under the control of ECU 100.

ECU 100 is an electronic control unit including an arithmetic processing unit that performs various arithmetic processing related to travel control of vehicles, and a memory that stores control programs and data. ECU 100 is an exemplary hybrid electric vehicle control device. ECU 100 functionally realizes a switching unit, an acquisition unit, and a setting unit, which will be described later.

An ignition switch 71, an accelerator operation amount sensor 72, a vehicle speed sensor 73, a water temperature sensor 74, and an SOC (State Of Charge) sensor 75 are electrically connected to ECU 100. The ignition switch 71 detects an on-off state of the ignition. The accelerator operation amount sensor 72 detects an operation position of the accelerator pedal. The vehicle speed sensor 73 detects hybrid electric vehicle 1 vehicle speed V. The water temperature sensor 74 detects the water temperature T, which is the temperature of the coolant of the engine 10. The water temperature T is an example of the temperature of the engine 10. Instead of the water temperature sensor 74, an oil temperature sensor that detects the temperature of the lubricating oil of the engine 10 may be provided.

SOC sensor 75 detects an SOC which is the amount of charge in the battery 18. When SOC sensor 75 is not provided, ECU 100 may calculate SOC based on the current value and the voltage value of the battery 18.

### Travel Switching Control

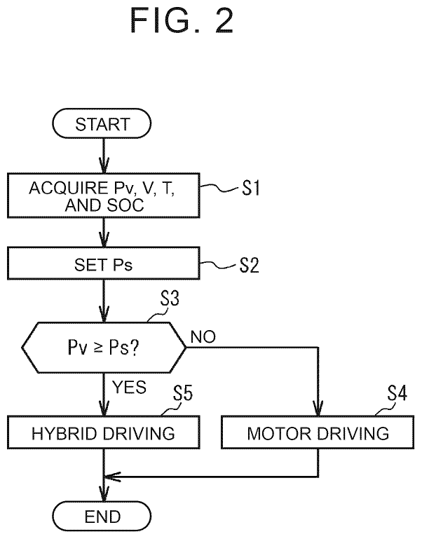

FIG. 2 is a flowchart illustrating the travel switching control. This control is repeatedly executed at predetermined intervals in a state where the ignition is on. ECU 100 acquires the requested driving force Pv, the vehicle speed V, the water temperature T, and SOC (S1). The requested driving force Pv is calculated by ECU 100 based on the accelerator operation amount, the operating condition, and the like. ECU 100 acquires the vehicle speed V, the water temperature T, and SOC by the vehicle speed sensor 73, the water temperature sensor 74, and SOC sensor 75, respectively. S1 is an exemplary process executed by the acquisition unit.

Next, ECU 100 sets the switching value Ps based on the vehicle speed V, the water temperature T, and SOC, which will be described in detail later (S2). S2 is an exemplary process executed by the setting unit. Next, ECU 100 determines whether or not the requested driving force Pv is equal to or greater than the switching value Ps (S3).

If S3 is No, ECU 100 performs motor driving (S4). In the motor driving, at least one of the first MG 14 and the second MG 15 is used as a power source while the engine 10 is stopped. In the motor driving, the engine 10 is stopped. This improves fuel efficiency.

If S3 is Yes, ECU 100 performs hybrid driving (S5). In the hybrid driving, the engine 10 is driven to perform traveling using the engine 10 as a power source. When at least one of the first MG 14 and the second MG 15 is used in combination with the engine 10, the hybrid driving is also included. In the hybrid driving, the engine 10 is driven. Therefore, acceleration responsiveness is improved and drivability is ensured.

### How to Set the Switching Value Ps

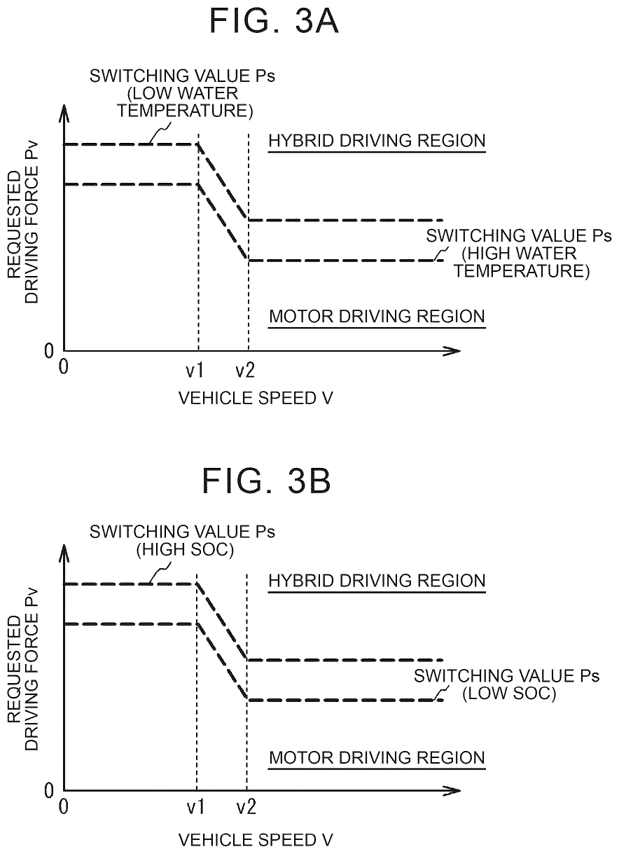

How to set the switching value Ps will be described. FIGS. 3A and 3B are illustrations of a map defining the switching value Ps. In the maps shown in FIGS. 3A and 3B, the vertical axis represents the requested driving force Pv, and the horizontal axis represents the vehicle speed V. FIG. 3A shows a case where SOC is constant and the water temperature T is low temperature and a case where the temperature is high. As shown in FIG. 3A, the switching value Ps is set to a larger value as the water temperature T is lower. In other words, the lower the water temperature T, the smaller the hybrid driving region. Since the efficiency of the engine 10 decreases as the water temperature T decreases, a decrease in fuel efficiency is reduced by reducing the hybrid driving region.

FIG. 3B shows a case where the water temperature T is constant and SOC is low and a case where the water temperature T is high. As shown in FIG. 3B, the switching value Ps is set to a larger value as SOC is higher. In other words, the higher SOC, the larger the motor driving region. As a result, the driving frequency of the engine 10 is suppressed, and the fuel efficiency is improved.

When the vehicle speed is less than the speed v1, the switching value Ps is constant. When the vehicle speed is greater than or equal to the speed v1 and less than the speed v2, the switching value Ps increases as the vehicle speed decreases. The vehicle speed is equal to or higher than the speed v2, and the switching value Ps is constant. As described above, the lower the vehicle speed V is, the larger the switching value Ps is set. Accordingly, when the vehicle speed V is low, the driving frequency of the engine 10 is suppressed and the fuel efficiency is improved.

Although the embodiments of the present disclosure have been described in detail above, the present disclosure is not limited to such specific embodiments, and various modifications and changes can be made within the scope of the gist of the present disclosure described in the claims.

What is claimed is:

1. A control device for a hybrid electric vehicle including an engine and a motor that are traction power sources, the control device comprising:
a switching unit configured to switch the hybrid electric vehicle to hybrid driving when a requested driving force requested to the hybrid electric vehicle is equal to or greater than a switching value, and to switch the hybrid electric vehicle to motor driving when the requested driving force is less than the switching value, the hybrid driving being driving in which the hybrid electric vehicle travels with power of the engine, and the motor driving being driving in which the hybrid electric vehicle travels with power of the motor;
an acquisition unit configured to acquire a temperature of the engine; and
a setting unit configured to set the switching value to a larger value as the temperature of the engine decreases.

2. The control device according to claim 1, wherein:
the acquisition unit is configured to acquire an amount of charge in a battery that is a power source of the motor; and
the setting unit is configured to set the switching value to a larger value as the amount of charge in the battery increases.

3. The control device according to claim 2, wherein:
the acquisition unit is configured to acquire a vehicle speed of the hybrid electric vehicle; and
the setting unit is configured to set the switching value to a larger value as the vehicle speed decreases.
